(19) United States
(12) Patent Application Publication
(10) Pub. No.: US 2009/0104589 A1
(43) Pub. Date: Apr. 23, 2009

(54) SYSTEMS AND METHODS FOR PROVIDING REMOTE TRAINING FOR A QUALITY ANALYSIS PROGRAM

(75) Inventor: Denton Bramwell, Layton, UT (US)

Correspondence Address: HOLLAND & HART LLP, 60 E. South Temple, Suite 2000, P.O. Box 11583, Salt Lake City, UT, 84110, US

(73) Assignee: PROMONTORY MANAGEMENT GROUP, INC., Layton, UT (US)

(21) Appl. No.: 12/253,100

(22) Filed: Oct. 16, 2008

Related U.S. Application Data
(60) Provisional application No. 60/980,836, filed on Oct. 18, 2007.

(51) Int. Cl. G09B 5/06; G09B 19/00

(52) U.S. Cl. 434/219; 434/307 R

(57) ABSTRACT

Systems and methods for providing remote training for a quality analysis program are disclosed. In certain embodiments, a computer-implemented method for providing remote training for a quality analysis program may comprise transmitting a first portion of a training program for a quality analysis program to a remote communication device, receiving a first transmission from the remote communication device, and transmitting a second portion of a training program to the remote communication device.

### CROSS REFERENCE TO RELATED APPLICATION

This application claims the benefit of the filing date of U.S. Provisional Application No. 60/980,836, filed Oct. 18, 2007, the disclosure of which is incorporated, in its entirety, by reference.

### BACKGROUND

Heightened consumer demand for highly reliable goods and services has made quality an increasingly important issue for businesses. This ever-growing consumer demand for quality has lead to an increased emphasis placed on quality control and improvement at virtually all levels of business operations, including engineering, manufacturing, distribution, and other administrative operations. Over the years, various quality analysis and improvement tools and programs have been developed in an attempt to aid businesses analyze and improve the quality of their processes and products by eliminating defects, i.e., nonconformities in a product or service. Examples of quality analysis and improvement tools and programs include SIX SIGMA, LEAN, PLAN-DO-CHECK-ACT, TOYOTA PRODUCTION SYSTEM, TOTAL QUALITY ANALYSIS, and other such tools and programs.

Training programs for conventional quality analysis and improvement tools and programs typically involve instructor-led classroom activities. Instructors of these training programs typically train employees or members of companies or organizations on how to implement the principles of a specific quality analysis program or tool. These programs may also involve the completion of one or more projects upon completion of the entire training curriculum. In these conventional programs, instructors physically travel to a point convenient for the client(s) and spend a few to several days. (1) helping the client set up the needed infrastructure and (2) teaching and coaching students who are participating in the program.

Conventional training programs, however, suffer from a number of drawbacks and deficiencies. For example, the expenses associated with requiring instructors to physically travel to and set up the requisite infrastructure for a training program may make such programs cost-prohibitive for small to medium size companies or represent a financial hardship for larger companies. The demanding travel schedule and large number of hours required of an instructor for conventional training programs may also increase the cost of the training program and reduce its availability and attractiveness. Travel time and expense also limit the areas where it is feasible to carry out such training programs. For example, instructors of quality analysis programs may not have access to potential clients in remote areas or less-developed countries.

In light of the expenses associated with conventional training programs, a large number of program participants may be required in order for the training program to be financially feasible. This again works to the disadvantage of all clients, but particularly to the disadvantage of small to medium size clients. For example, participants in the training program may be required to miss work for a significant period of time to attend the training program. For many companies, the lost productivity suffered by having a number of key employees away from their work may be unacceptable. In addition, while these participants are away from work their regular tasks or work accumulates. Program participates must then carefully balance the time required to implement the principles learned in the training program with the demands of this accumulated work.

Conventional training programs for quality analysis and improvement programs are also fundamentally “batch-based” processes. That is, one or two dozen program participants are brought together for training, in a batch. The adverse effect of this batch-based system is that the quality improvement principles of a quality analysis program may only be implemented upon completion of the entire curriculum of a training program, not when the client needs the improvements. Moreover, because principles learned late in the training program are often not needed for a few to several weeks or months, participants may forget how to apply these principles when an appropriate time to apply the principles finally arrives.

### SUMMARY

According to at least one embodiment, a computer-implemented method for providing remote training for a quality analysis program may comprise transmitting a first portion of a training program for a quality analysis program to a remote communication device, receiving a first transmission from the remote communication device, and transmitting a second portion of the training program to the remote communication device. The training program may comprise a plurality of lessons and transmitting the first portion of the training program may comprise transmitting a first lesson of the training program to the remote communication device. Similarly, transmitting the second portion of the training program may comprise transmitting a second lesson of the training program to the remote communication device. In at least one embodiment, the first lesson may comprise instructions for performing a first quality analysis test and the first transmission from the remote communication device may comprise results of the first quality analysis test. Similarly, the second lesson may comprise instructions for performing a second quality analysis test.

Transmitting the first portion of the training program to the remote communication device may comprise transmitting pre-recorded video, pre-recorded voice, live video, live voice, an electronic document, a screenshot of the quality analysis software program, or certification examination materials. In addition, the quality analysis program may comprise a SIX SIGMA quality analysis program, a LEAN quality analysis program, a PLAN-DO-CHECK-ACT quality analysis program, a TOYOTA PRODUCTION SYSTEM quality analysis program, and/or a TOTAL QUALITY ANALYSIS quality analysis program. In certain embodiments, the training program may comprise a certification examination. In this embodiment, transmitting the first portion of the training program may comprise transmitting at least a portion of the certification examination to the remote communication device. In addition, receiving the first transmission from the remote communication device may comprise receiving answers to questions on the certification examination, and transmitting the second portion of the training program to the remote communication device may comprise transmitting a certification examination score to the remote communication device. In addition, receiving the first transmission from the remote communication device may comprise receiving pre-recorded video, pre-recorded voice, live video, live voice, an electronic document, a request for an addition portion of the training program, a result of the quality analysis test, or answers to the certification examination.

In certain embodiments, the first transmission may be received after the first portion of the training program is transmitted while the second portion of the training program may be transmitted after receiving the first transmission from the remote communication device. In addition, transmitting the first portion of the training program to the remove communication device may comprise simultaneously transmitting the first portion of the training program to a plurality of remote communication devices. Additional systems and methods for providing remote training for a quality analysis program are also disclosed.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an exemplary system for providing remote training for a quality analysis program according to at least one embodiment.

FIG. 2 is a flow diagram of an exemplary method for providing remote training for a quality analysis program according to at least one embodiment.

FIG. 3 is a flow diagram of an exemplary method for providing remote training for a quality analysis program according to an additional embodiment.

FIG. 4 is a flow diagram of an exemplary method for providing remote training for a quality analysis program according to an additional embodiment.

FIG. 5 is a block diagram of an exemplary computing system capable of implementing one or more of the embodiments described and/or illustrated herein.

FIG. 6 is a block diagram of an exemplary computing system capable of implementing one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION

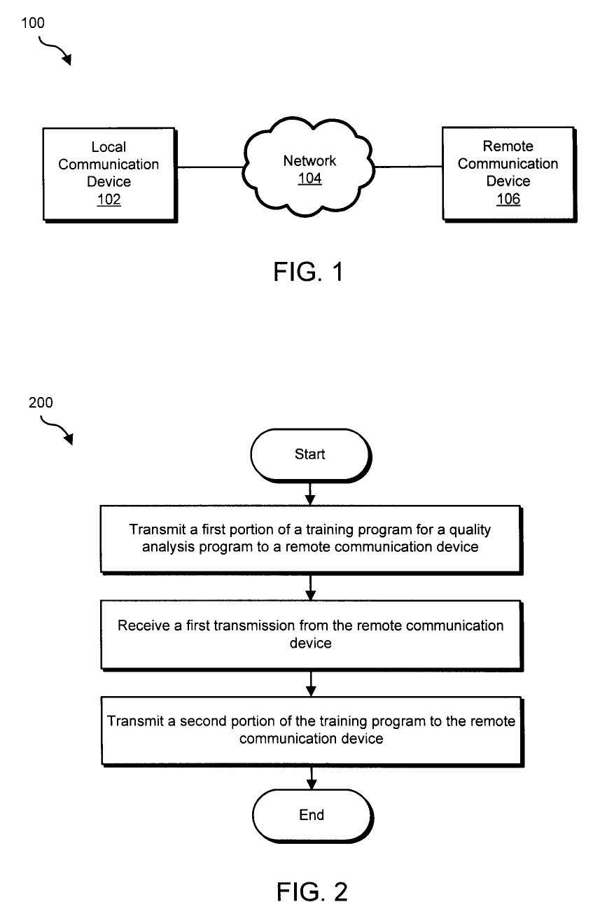

The instant disclosure relates generally to systems and methods for providing remote training for a quality analysis program. FIG. 1 is an illustration of an exemplary system 100 for providing remote training for a quality analysis program. As illustrated in this figure, exemplary system 100 may comprise a local communication device 102, a network 104, and a remote communication device 106. Local communication device 102 and remote communication device 106 generally represent any type or form of communication device. Examples of local communication device 102 and remote communication device 106 include, without limitation, computing devices, video conferencing devices, telephonic conferencing devices, telephones (including cellular telephones), and the like. In certain embodiments, remote communication device 106 may be located in an area or location that is different from the location in which local communication device 102 is located.

In at least one embodiment, local communication device 102 may communicate with remote communication device 106 via network 104. Network 104 generally represents any telecommunication or computer network. Examples of network 104 include, without limitation, a local area network (LAN), a wide area network (WAN), a personal area network (PAN), an intranet, the Internet, a telephone or cable network, a cellular telephone network, a satellite data network, or any other suitable network. Any type or form of data may be transmitted between local communication device 102 and remote communication device 106 via network 104. Examples of the type of data that may be transmitted between local communication device 102 and remote communication device 106 include, without limitation, pre-recorded video, pre-recorded voice, live video, live voice, electronic documents, software programs, and the like. In certain embodiments, exemplary system 100 may be a full-duplex system; that is, communication between local communication device 102 and remote communication device 106 may occur in both directions (i.e., from local communication device 102 to remote communication device 106 and from remote communication device 106 to local communication device 102) simultaneously.

Although illustrated as single devices, local communication device 102 and/or remote communication device 106 may comprise additional devices. For example, local communication device 102 may comprise a plurality of local communication devices 102. Similarly, remote communication device 106 may comprise a plurality of remote communication devices. In certain embodiments, local communication device 102 may be configured to simultaneously communicate with a plurality of remote communication devices, such as remote communication device 106.

As detailed above, system 100 in FIG. 1 may be used to provide remote training for a quality analysis program to a remote communication device. For example, as will be explained in greater detail below, one or more instructors of a quality analysis program may, using local communication device 102, transmit all or a portion of a training program for a quality analysis program to one or more remote program participants utilizing remote communication device 106 via network 104. As used herein, the phrase “quality analysis program” generally refers to quality analysis improvement tools or programs used to analyze and improve the quality of processes and products. Examples of quality analysis programs include, without limitations, SIX SIGMA, LEAN, PLAN-DO-CHECK-ACT, TOYOTA PRODUCTION SYSTEM, TOTAL QUALITY ANALYSIS, and other such tools and programs.

Similarly, the phrase “training program” may refer to any type or form of training or certification program for instructing or training one or more program participants on how to implement a quality analysis program. Training programs may comprise a variety of training materials. For example, training programs may comprise, without limitation, pre-recorded video, pre-recorded voice, live video, live voice, electronic documents, quality analysis software programs (such as, for example, the quality analysis software program described in U.S. patent application Ser. No. 11/220,800, filed on 7 Sep. 2005), certification examination materials, and the like. In certain embodiments, training programs may be divided into one or more lessons. Each lesson in a training program may also comprise incremental instructions on how to implement a quality analysis program and/or perform quality analysis tests, projects, or experiments that, when performed, may identify ways to improve the quality of a product or process.

FIG. 2 is a block diagram of an exemplary computer-implemented method 200 for providing remote training for a quality analysis program according to at least one embodiment. In certain embodiments, one or more of the steps illustrated in FIG. 2 may be implemented using exemplary system 100. As illustrated in FIG. 2, at step 202 a first portion of a training program for a quality analysis program may be transmitted to a remote communication device, such as remote communication device 106 in FIG. 1. As detailed above, the training program referenced in step 202 may represent any type or form of training or certification program for a quality analysis program. In certain embodiments, transmitting a first portion of this training program in step 202 may comprise transmitting pre-recorded video, pre-recorded voice, live video, live voice, electronic documents, screenshots of a quality analysis software program, certification examination materials, or the like to the remote communication device.

Step 202 may be performed in a variety of ways. For example, step 202 may comprise transmitting a first portion of a training program from local communication device 102 in FIG. 1 to remote communication device 106 via network 104. In addition, since, as detailed above, local communication device 102 and/or remote communication device 106 may comprise a plurality of communication devices, in certain embodiments step 202 may comprise simultaneously transmitting a first portion of a training portion for a quality analysis program from local communication device 102 to a plurality of remote communication devices 106. Similarly, simultaneously transmitting a first portion of a training portion for a quality analysis program from a plurality of local communication devices 102 to one or more remote communication devices 106.

Returning to FIG. 2, at step 204 a first transmission may be received from the remote communication device. As explained in greater detail below, the first transmission received from the remote communication device in step 204 may comprise any type or form of information. In certain embodiments, this first transmission may comprise pre-recorded video, pre-recorded voice, live video, live voice, electronic documents, an indication that a first lesson of the training program is complete, the results of performing quality analysis test or experiment, answers to a certification examination, or the like.

At step 206, a second portion of the training program may be transmitted to the remote communication device. As with the first portion detailed in step 202, the second portion of the training program transmitted to the remote communication device may comprise pre-recorded video, pre-recorded voice, live video, live voice, an electronic document, a screenshot of a quality analysis software program, certification examination materials, or the like. In certain embodiments, the first transmission detailed in step 204 may be received only after the first portion of the training program is transmitted in step 202. Similarly, the second portion of the training program detailed in step 206 may be transmitted only after receiving the first transmission from the remote communication device detailed in step 204. Upon transmitting the second portion of the training program in step 206, the process flow exemplary method 200 may terminate.

For the sake of clarity, and by way of example only, the following detailed description will provide an illustration of how exemplary method 200 in FIG. 2 may be implemented using exemplary system 100 in FIG. 1. In certain embodiments, one or more instructors or experts of a quality analysis program may train or instruct one or more remote participants on how to implement the principles of a quality analysis program by communicating with the remote participants using exemplary system 100. For example, one or more instructors may instruct one or more remote program participants by transmitting, using local communication device 102, an instructional video to remote communication device 106, which may be operated by the remote program participants, that explains how to perform all or portions of a quality analysis test or experiment that may be used to identify ways to improve the quality of a product or process.

Upon receiving and watching the instructional video, the remote program participants may immediately apply the principles learned in the video by completing tasks or activities detailed in the instructional video or by performing a quality analysis test or experiment on a pre-identified product or process. Since exemplary system 100 may represent a full-duplex system, the instructors operating local communication device 102 may observe, via a web cam, a microphone, or the like, the progress of the remote participants as they complete these tasks or activities. Remote program participants are also free to ask, using exemplary system 100, the instructors questions as they proceed. Upon completion of these tasks or activities, the remote program participants may request, using exemplary system 100, additional lessons, instructions, or instructional materials from the instructors.

Alternatively, upon receiving and watching the instructional video, the remote program participants may return to their regular work tasks and attempt to apply the principles learned from the video without the aid of the instructors. The remote program participants may then communicate, using exemplary system 100, on an as-needed basis with the instructors as questions arise or as additional instruction is required.

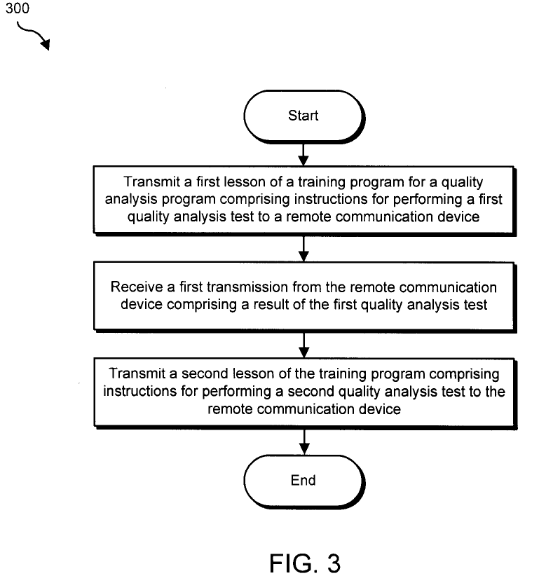

As detailed above, a training program for a quality analysis program may comprise a plurality of lessons. FIG. 3 is an illustration of an exemplary computer-implemented method 300 for providing remote training for a quality analysis program that may comprise transmitting one or more lessons to a remote communication device. As illustrated in this figure, at step 302 a first lesson of a training program for a quality analysis program may be transmitted to a remote communication device. As detailed above, this first lesson may comprise a variety of information or data, such as instructional videos, live video or voice instruction, electronic instructional materials, screenshots of a quality analysis software program, electronic certification examination materials, or the like. In at least one embodiment, this first lesson may comprise instructional materials providing instructions on how to perform a first quality analysis test.

Upon receiving the first lesson in step 302, the remote program participants may read, watch, or listen to the first lesson and then apply one or more principles taught in the first lesson. For example, as detailed above, the remote program participants may perform a first quality analysis test on pre-identified products or processes applying the principles taught in the first lesson.

In certain embodiments, upon applying this first quality analysis test, the remote program participants may transmit, using remote communication device 106, a first transmission to the local communication device 102. At step 304, this first transmission may be received from remote communication device 106. In at least one embodiment, this first transmission may comprise the results of the first quality analysis test performed by the remote program participants. As detailed above, this first transmission may also comprise a request for additional lessons and/or instructional materials. At step 306, a second lesson of the training program comprising instructions for a second quality analysis test may be transmitted to the remote communication device. The process flow of exemplary method 300 may then terminate.

In at least one embodiment, exemplary system 100 may be used to administer a certification examination used to certify subject matter experts for a certain quality analysis tool or program. The phrase “certification examination,” as used herein, generally refers to an examination or test used to test and certify subject matter experts of a certain quality analysis tool or program. For example, this certification examination may be used to certify subject matter experts for a SIX SIGMA quality analysis program, a LEAN quality analysis program, a PLAN-DO-CHECK-ACT quality analysis program, a TOYOTA PRODUCTION SYSTEM quality analysis program, and/or a TOTAL QUALITY ANALYSIS quality analysis program.

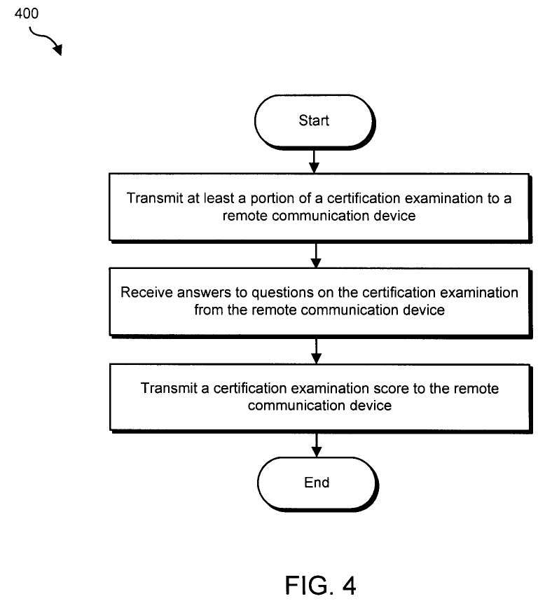

FIG. 4 is a block diagram of an exemplary computer-implemented method 400 for remotely administering a certification examination for a quality analysis program. As illustrated in this figure, at step 402 at least a portion of a certification examination may be transmitted to a remote communication device, such as remote communication device 106 in FIG. 1. Once the remote program participants have received the certification examination, the remote program participants may begin completing the certification examination. Since exemplary system 100 may represent a full-duplex system, the instructors operating local communication device 102 may observe, via a web cam, a microphone, or the like, the progress of the remote participants as they complete the certification examination to ensure the integrity of the examination.

Upon completing the certification examination, the remote program participants may, using remote communication device 106, transmit answers to the certification examination to the instructors operating local communication device 102. At step 404, these answers to questions on the certification examination may be received by local communication device 102 from remote communication device 106. These answers may then be graded, and at step 406 a certification examination score may be transmitted to remote communication device 106. The process flow of exemplary method 400 in FIG. 4 may then terminate.

The exemplary embodiments disclosed herein may provide a number of benefits over the prior art. For example, training program costs may be decreased since the expense and time associated with travel is virtually eliminated. Moreover, the reduced travel demands may allow training program instructors to reduce the fees charged, which may allow small to medium sized organizations to participate in such training programs. These reduced or eliminated travel demands may also allow training sessions to be conducted with participants in remote locations and/or less-developed countries.

The systems and methods disclosed herein are also infinitely scalable; that is, they may be used to simultaneously instruct both a single participant or a plurality of participants dispersed throughout a plurality of remote locations. In addition, because the amount of time that program participants must spend away from work is minimized, employee downtime may be minimized. Training program sessions may be conducted as the needs of a company or organization are identified, as opposed to waiting to conduct a training program session until a classroom full of participants may be conveniently assembled. Moreover, since program participants may immediately apply the principles learned, the effectiveness of the training program may be improved.

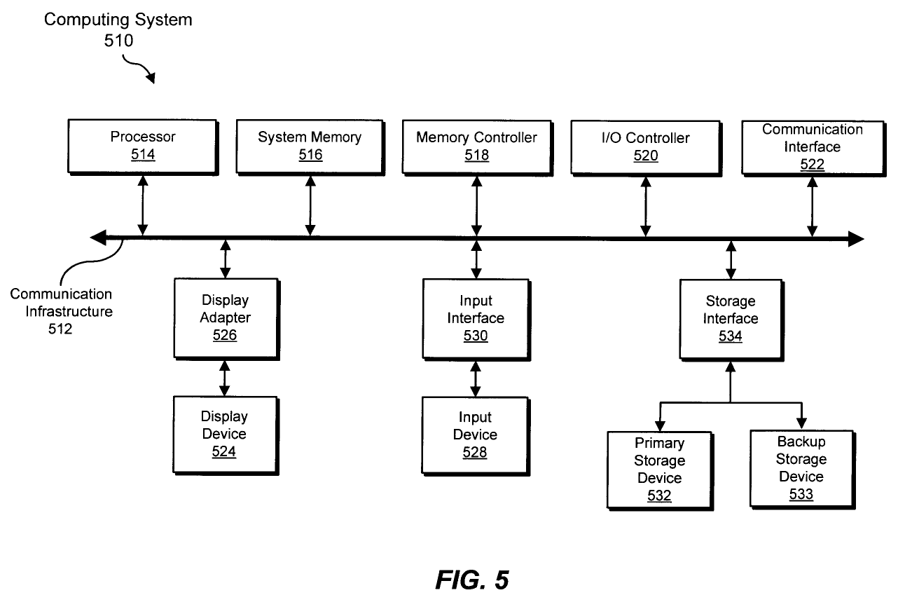

FIG. 5 is a block diagram of an exemplary computing system 510 capable of implementing one or more of the embodiments described and/or illustrated herein. Computing system 510 broadly represents any single or multi-processor computing device or system capable of executing computer-readable instructions. Examples of computing system 510 include, without limitation, workstations, laptops, client-side terminals, servers, distributed computing systems, handheld devices, or any other computing system or device. Computing device 510 may also represent a local communication device (such as local communication device 102 in FIG. 1) and/or a remote communication device (such as remote communication device 106 in FIG. 1). In its most basic configuration, computing system 510 may comprise at least one processor 514 and a system memory 516.

Processor 514 generally represents any type or form of processing unit capable of processing data or interpreting and executing instructions. In certain embodiments, processor 514 may receive instructions from a software application or module. These instructions may cause processor 514 to perform the functions of one or more of the exemplary embodiments described and/or illustrated herein. For example, processor 514 may perform and/or be a means for performing, either alone or in combination with other elements, one or more of the transmitting and receiving steps described herein. Processor 514 may also perform and/or be a means for performing any other steps, methods, or processes described and/or illustrated herein.

System memory 516 generally represents any type or form of volatile or non-volatile storage device or medium capable of storing data and/or other computer-readable instructions. Examples of system memory 516 include, without limitation, random access memory (RAM), read only memory (ROM), flash memory, or any other suitable memory device. Although not required, in certain embodiments computing device 510 may comprise both a volatile memory unit (such as, for example, system memory 516) and a non-volatile storage device (such as, for example, primary storage device 532, as described in detail below).

In certain embodiments, exemplary computing system 510 may also comprise one or more components or elements in addition to processor 514 and system memory 516. For example, as illustrated in FIG. 5, computing system 510 may comprise a memory controller 518, an Input/Output (I/O) controller 518, and a communication interface 522, each of which may be interconnected via a communication infrastructure 512. Communication infrastructure 512 generally represents any type or form of infrastructure capable of facilitating communication between one or more components of a computing device. Examples of communication infrastructure 512 include, without limitation, a communication bus (such as an ISA, PCI, PCIe, or similar bus) and a network.

Memory controller 518 generally represents any type or form of device capable of handling memory or data or controlling communication between one or more components of computing system 510. For example, in certain embodiments memory controller 518 may control communication between processor 514, system memory 516, and I/O controller 520 via communication infrastructure 512. In certain embodiments, memory controller may perform and/or be a means for performing, either alone or in combination with other elements, one or more of the steps or features described and/or illustrated herein, such as transmitting and receiving.

I/O controller 520 generally represents any type or form of module capable of coordinating and/or controlling the input and output functions of a computing device. For example, in certain embodiments I/O controller may control or facilitate transfer of data between one or more elements of computing system 510, such as processor 514, system memory 516, communication interface 522, display adapter 526, input interface 530, and storage interface 534. I/O controller 520 may be used, for example, to perform and/or be a means for performing, either alone or in combination with other elements, one or more of the transmitting and receiving steps described herein. I/O controller 520 may also be used to perform and/or be a means for performing other steps and features set forth in the instant disclosure.

Communication interface 522 broadly represents any type or form of communication device or adapter capable of facilitating communication between exemplary computing system 510 and one or more additional devices. For example, in certain embodiments communication interface 522 may facilitate communication between computing system 510 and a private or public network comprising additional computing systems. Examples of communication interface 522 include, without limitation, a wired network interface (such as a network interface card), a wireless network interface (such as a wireless network interface card), a modem, and any other suitable interface. In at least one embodiment, communication interface 522 may provide a direct connection to a remote server via a direct link to a network, such as the Internet. Communication interface 522 may also indirectly provide such a connection through, for example, a local area network (such as an Ethernet network), a personal area network (such as a BLUETOOTH network), a telephone or cable network, a cellular telephone connection, a satellite data connection, or any other suitable connection.

In certain embodiments, communication interface 522 may also represent a host adapter configured to facilitate communication between computing system 510 and one or more additional network or storage devices via an external bus or communications channel. Examples of host adapters include, without limitation, SCSI host adapters, USB host adapters, IEEE 1394 host adapters, SATA and eSATA host adapters, ATA and PATA host adapters, Fibre Channel interface adapters, Ethernet adapters, or the like. Communication interface 522 may also allow computing system 510 to engage in distributed or remote computing. For example, communication interface 522 may receive instructions from a remote device or send instructions to a remote device for execution. In certain embodiments, communication interface 522 may perform and/or be a means for performing, either alone or in combination with other elements, one or more of the transmitting and receiving steps described herein. Communication interface 522 may also be used to perform and/or be a means for performing other steps and features set forth in the instant disclosure.

As illustrated in FIG. 5, computing system 510 may also comprise at least one display device 524 coupled to communication infrastructure 512 via a display adapter 526. Display device 524 generally represents any type or form of device capable of visually displaying information forwarded by display adapter 526. Similarly, display adapter 526 generally represents any type or form of device configured to forward graphics, text, and other data from communication infrastructure 512 (or from a frame buffer, as known in the art) for display on display device 524.

As illustrated in FIG. 5, exemplary computing system 510 may also comprise at least one input device 528 coupled to communication infrastructure 512 via an input interface 530. Input device 528 generally represents any type or form of input device capable of providing input, either computer or human generated, to exemplary computing system 510. Examples of input device 528 include, without limitation, a keyboard, a pointing device, a speech recognition device, or any other input device. In at least one embodiment, input device 528 may perform and/or be a means for performing, either alone or in combination with other elements, one or more of the transmitting and receiving steps described herein. Input device 528 may also be used to perform and/or be a means for performing other steps and features set forth in the instant disclosure.

As illustrated in FIG. 5, exemplary computing system 510 may also comprise a primary storage device 532 and a backup storage device 533 coupled to communication infrastructure 512 via a storage interface 534. Storage devices 532 and 533 generally represent any type or form of storage device or medium capable of storing data and/or other computer-readable instructions. For example, storage devices 532 and 533 may be a magnetic disk drive (e.g., a so-called hard drive), a floppy disk drive, a magnetic tape drive, an optical disk drive, a flash drive, or the like. Storage interface 534 generally represents any type or form of interface or device for transferring data between storage devices 532 and 533 and other components of computing system 510.

In certain embodiments, storage devices 532 and 533 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 532 and 533 may also comprise other similar structures or devices for allowing computer software, data, or other computer-readable instructions to be loaded into computing system 510. For example, storage devices 532 and 533 may be configured to read and write software, data, or other computer-readable information. Storage devices 532 and 533 may also be a part of computing system 510 or may be a separate device accessed through other interface systems. Storage devices 532 and 533 may also be used, for example, to perform and/or be a means for performing, either alone or in combination with other elements, one or more of the transmitting and receiving steps described herein. Storage devices 532 and 533 may also be used to perform and/or be a means for performing other steps and features set forth in the instant disclosure.

Many other devices or subsystems may be connected to computing system 510. Conversely, all of the components and devices illustrated in FIG. 5 need not be present to practice the embodiments descried and/or illustrated herein. The devices and subsystems referenced above may also be interconnected in different ways from that shown in FIG. 5. Computing system 510 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The phrase “computer-readable medium” generally refers to any form of device, carrier, or medium capable of storing or carrying computer-readable instructions. Examples of computer-readable media include recordable media (such as floppy disks and CD- or DVD-ROMs), transmission-type media (such as carrier waves), electronic-storage media, magnetic-storage media, optical-storage media, and other distribution systems.

The computer-readable medium containing the computer program may then be loaded into computing system 510. All or a portion of the computer program stored on the computer-readable medium may then be stored in system memory 516 and/or various portions of storage devices 532 and 533. When executed by processor 514, a computer program loaded into computing system 510 may cause processor 514 to perform and/or be a means for performing the functions of one or more of the exemplary embodiments described and/or illustrated herein. Additionally or alternatively, one or more of the exemplary embodiments described and/or illustrated herein may be implemented in firmware and/or hardware. For example, computing system 510 may be configured as an application specific integrated circuit (ASIC) adapted to implement one or more of the exemplary embodiments disclosed herein.

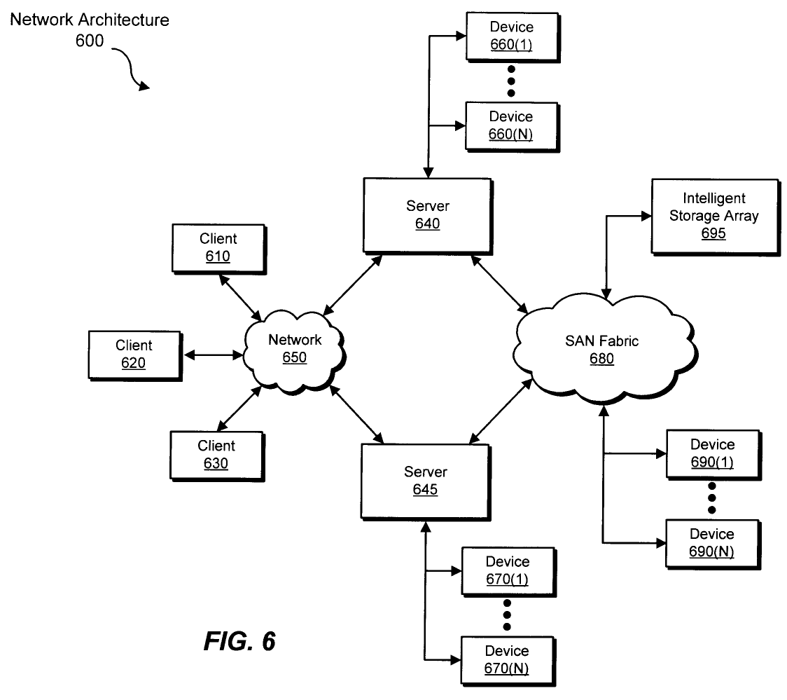

FIG. 6 is a block diagram of an exemplary network architecture 600 in which client systems 610, 620, and 630 and servers 640 and 645 may be coupled to a network 650. Client systems 610, 620, and 630 generally represent any type or form of computing device or system, such as exemplary computing system 510 in FIG. 5. Similarly, servers 640 and 645 generally represent computing devices or systems, such as application servers or database servers, configured to provide various database services and/or to run certain software applications. Network 650 generally represents any telecommunication or computer network; including, for example, an intranet, a wide area network (WAN), a local area network (LAN), a personal area network (PAN), or the Internet.

As illustrated in FIG. 6, one or more storage devices 660(1)-(N) may be directly attached to server 640. Similarly, one or more storage devices 690(1)-(N) may be directly attached to server 645. Storage devices 660(1)-(N) and storage devices 690(1)-(N) generally represent any type or form of storage device or medium capable of storing data and/or other computer-readable instructions. In certain embodiments, storage devices 660(1)-(N) and storage devices 690(1)-(N) may represent network-attached storage (NAS) devices configured to communicate with servers 640 and 645 using various protocols, such as NFS, SMB, or CIFS.

Servers 640 and 645 may also be connected to a storage area network (SAN) fabric 680. SAN fabric 680 generally represents any type or form of computer network or architecture capable of facilitating communication between a plurality of storage devices. SAN fabric 680 may facilitate communication between servers 640 and 645 and a plurality of storage devices 690(1)-(N) and/or an intelligent storage array 695. SAN fabric 680 may also facilitate, via network 650 and servers 640 and 650, communication between client systems 610, 620, and 630 and storage devices 690(1)-(N) and/or intelligent storage array 695 in such a manner that devices 690(1)-(N) and array 695 appear as locally attached devices to client systems 610, 620, and 630. As with storage devices 660(1)-(N) and storage devices 670(1)-(N), storage devices 690(1)-(N) and intelligent storage array 695 generally represent any type or form of storage device or medium capable of storing data and/or other computer-readable instructions.

In certain embodiments, and with reference to exemplary computing system 510 of FIG. 5, a communication interface, such as communication interface 522 in FIG. 5, may be used to provide connectivity between each client system 610, 620, and 630 and network 650. Client systems 610, 620, and 630 may be able to access information on server 640 or 645 using, for example, a web browser or other client software. Such software may allow client systems 610, 620, and 630 to access data hosted by server 640, server 645, storage devices 660(1)-(N), storage devices 670(1)-(N), storage devices 690(1)-(N), or intelligent storage array 695. Although FIG. 6 depicts the use of a network (such as the Internet) for exchanging data, the embodiments described and/or illustrated herein are not limited to the Internet or any particular network-based environment.

In at least one embodiment, all or a portion of one or more of the exemplary embodiments disclosed herein may be encoded as a computer program and loaded onto and executed by server 640, server 645, storage devices 660(1)-(N), storage devices 670(1)-(N), storage devices 690(1)-(N), intelligent storage array 695, or any combination thereof. All or a portion of one or more of the exemplary embodiments disclosed herein may also be encoded as a computer program, stored in server 640, run by server 645, and distributed to client systems 610, 620, and 630 over network 650. Accordingly, network architecture 600 may perform and/or be a means for performing, either alone or in combination with other elements, one or more of the transmitting and receiving steps described herein.

In addition, in certain embodiments client systems 610, 620, and 630 may represent remote communication devices (such as remote communication device 106 in FIG. 1), while server 640, server 645, storage devices 660(1)-(N), storage devices 670(1)-(N), storage devices 690(1)-(N), intelligent storage array 695, or any combination thereof may represent one or more local communication devices (such as local communication device 102 in FIG. 1).

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

The process parameters and sequence of steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

Furthermore, while various embodiments have been described and/or illustrated herein in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “a” or “an,” as used in the specification and claims, are to be construed as meaning “at least one of.” In addition, for ease of use, the words “including” and “having,” as used in the specification and claims, are interchangeable with and have the same meaning as the word “comprising.”

What is claimed is:

1. A computer-implemented method for providing remote training for a quality analysis program, the method comprising:
transmitting a first portion of a training program for a quality analysis program to a remote communication device;
receiving a first transmission from the remote communication device; and
transmitting a second portion of the training program to the remote communication device.

2. The method of claim 1, wherein the training program comprises a plurality of lessons and transmitting the first portion of the training program comprises transmitting a first lesson of the training program to the remote communication device.

3. The method of claim 2, wherein transmitting the second portion of the training program comprises transmitting a second lesson of the training program to the remote communication device.

4. The method of claim 3, wherein the first lesson comprises instructions for performing a first quality analysis test and the first transmission from the remote communication device comprises results of the first quality analysis test.

5. The method of claim 4, wherein the second lesson comprises instructions for performing a second quality analysis test.

6. The method of claim 1, wherein transmitting the first portion of the training program to the remote communication device comprises transmitting at least one of:
pre-recorded video;
pre-recorded voice;
live video;
live voice;
an electronic document;
a screenshot of a quality analysis software program; and
certification examination materials.

7. The method of claim 1, wherein the quality analysis program comprises at least one of:
a SIX SIGMA quality analysis program;
a LEAN quality analysis program;
a PLAN-DO-CHECK-ACT quality analysis program;
a THEORY OF CONSTRAINTS quality analysis program;
a TOYOTA PRODUCTION SYSTEM quality analysis program; and
a TOTAL QUALITY ANALYSIS quality analysis program.

8. The method of claim 1, wherein:
the training program comprises a certification examination;
transmitting the first portion of the training program comprises transmitting at least a portion of the certification examination to the remote communication device;
receiving the first transmission from the remote communication device comprises receiving answers to questions on the certification examination; and
transmitting the second portion of the training program to the remote communication device comprises transmitting a certification examination score to the remote communication device.

9. The method of claim 1, wherein receiving the first transmission from the remote communication device comprises receiving at least one of:
pre-recorded video;
pre-recorded voice;
live video;
live voice;
an electronic document;
a request for an additional portion of the training program;
a result of a quality analysis test; and
answers to a certification examination.

10. The method of claim 1, wherein the first transmission is received after the first portion of the training program is transmitted and the second portion of the training program is transmitted after receiving the first transmission from the remote communication device.

11. The method of claim 1, wherein transmitting the first portion of the training program to the remote communication device comprises simultaneously transmitting the first portion of the training program to a plurality of remote communication devices.

12. A computer-readable medium comprising one or more computer-executable instructions that, when executed by a computing system, cause the computing system to perform a method for providing remote training for a quality analysis program, the method comprising:
transmitting a first portion of a training program for a quality analysis program to a remote communication device;
after transmitting the first portion of the training program, receiving a first transmission from the remote communication device; and
after receiving the first transmission from the remote communication device, transmitting a second portion of the training program to the remote communication device.

13. A system for providing remote training for a quality analysis program, the system comprising:
a communication interface configured to:
transmit a first portion of a training program for a quality analysis program to a remote communication device;
receive a first transmission from the remote communication device; and
transmit a second portion of the training program to the remote communication device.

14. A computer-implemented method for providing remote training for a quality analysis program, the method comprising:
transmitting a first lesson of a training program for a quality analysis program to a remote communication device, the first lesson comprising instructions for performing a first quality analysis test;
receiving a first transmission from the remote communication device, the first transmission comprising a result of the first quality analysis test; and
transmitting a second lesson of the training program to the remote communication device, the second lesson comprising instructions for performing a second quality analysis test.
